(19) United States
(12) Patent Application Publication
(10) Pub. No.: US 2016/0124723 A1
(43) Pub. Date: May 5, 2016

(54) GRAPHICALLY BUILDING ABSTRACT SYNTAX TREES

(71) Applicant: Weixi Ma, Lexington, KY (US)

(72) Inventor: Weixi Ma, Lexington, KY (US)

(21) Appl. No.: 14/529,552

(22) Filed: Oct. 31, 2014

(51) Int. Cl. G06F 9/45; G06F 3/0484; G06F 3/0482

(52) U.S. Cl. CPC G06F 8/427; G06F 3/0482; G06F 3/04842

(57) ABSTRACT

Graphically building an abstract syntax tree includes displaying a user interface comprising a canvas and a presentation pane; displaying on the canvas a depiction of the abstract syntax tree; and displaying within the presentation pane a plurality of elements, wherein each of the plurality of elements is selectable as a visual node to add to the depiction of the abstract syntax tree. The method also includes receiving first input indicating selection of one of the plurality of elements; and adding to the canvas a first node in the depiction of the abstract syntax tree with a first visual label related to the one of the plurality of elements.

### BACKGROUND

The present invention relates to abstract syntax trees and, more particularly, to a general user interface for creating abstract syntax trees.

Computer programming typically comprises writing high level code. The high level code is then translated into an abstract syntax tree and then into low level machine executable code. Low level computer programming languages are difficult for an individual to code fluently, and they often contain hardware specific nuances. High level programming languages are easier for the individual to grasp and can be converted into machine executable code by a compiler. However, high level programming languages still contain strict syntax rules. Furthermore, they must be heavily commented for semantic readability. Abstract syntax trees, on the other hand, are semantically readable and have simpler syntax rules. Abstract syntax trees can also be converted directly to machine executable code by a compiler.

### SUMMARY

Embodiments of the present invention relate to a method for graphically building an abstract syntax tree. The method includes displaying a user interface comprising a canvas and a presentation pane; displaying on the canvas a depiction of the abstract syntax tree; and displaying within the presentation pane a plurality of elements, wherein each of the plurality of elements is selectable as a visual node to add to the depiction of the abstract syntax tree. The method also includes receiving first input indicating selection of one of the plurality of elements; and adding to the canvas a first node in the depiction of the abstract syntax tree with a first visual label related to the one of the plurality of elements.

### BRIEF DESCRIPTION OF THE DRAWINGS

FIG. 1 illustrates a view of a user interface wherein a presentation pane is placed on one side of a canvas. The canvas further displays several nodes represented as a text label in a box. Lines connect the nodes to represent the relationship between immediately related nodes. The overall structure of the nodes and relationships forming the abstract syntax tree is depicted visually as a tree on the canvas.

FIG. 2 illustrates a view of the interface of FIG. 1 wherein a compressed abstract syntax tree is represented by a single box with a text label. In this embodiment, the compressed abstract syntax tree is presented to the user in the presentation pane for selection and use on the canvas. Furthermore, the compressed abstract syntax tree may be expanded.

FIG. 3 illustrates a logical representation of the abstract syntax tree represented by the graphical representation 106 of FIG. 1.

FIG. 4 illustrates a flow chart of an embodiment of the interface of FIG. 1 wherein two elements and a relationship data are received and an abstract syntax tree is built.

FIG. 5 illustrates a flow chart of an embodiment of the interface of FIG. 1 wherein a portion of an abstract syntax tree is stored as a custom element.

FIG. 6 illustrates a flow chart of an embodiment of the interface of FIG. 1 wherein a custom element representing a portion of an abstract syntax tree is presented and used in an abstract syntax tree.

FIG. 7 illustrates a flow chart of an embodiment of the interface of FIG. 1 wherein a node is moved in the tree via the interface.

FIG. 8 illustrates a flow chart of an embodiment of the interface of FIG. 1 wherein a node is deleted via the interface.

FIG. 9 is a block diagram of a computer system having a computer readable storage medium for implementing functions according to various aspects of the present invention as described in greater detail herein.

### DETAILED DESCRIPTION

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and “comprising,” when used in this specification, specify the presence of stated features, steps, operations, elements, and/or components, but do not preclude the presence or addition of one or more other features, steps, operations, elements, components, and/or groups thereof. Storage by computer may mean by hard drive, memory, or other storage device. Receiving a selection, receiving a user selection, receiving a selected element, and other interactions with the user may be accomplished by event, drag and drop, queries, interrupts, signals, polling, dialog, command, etc.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. Additionally, functional programming languages, such as Erlang, OCaml, Haskell, and the like, may be used for the computer program code to carry out operations of the present invention. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

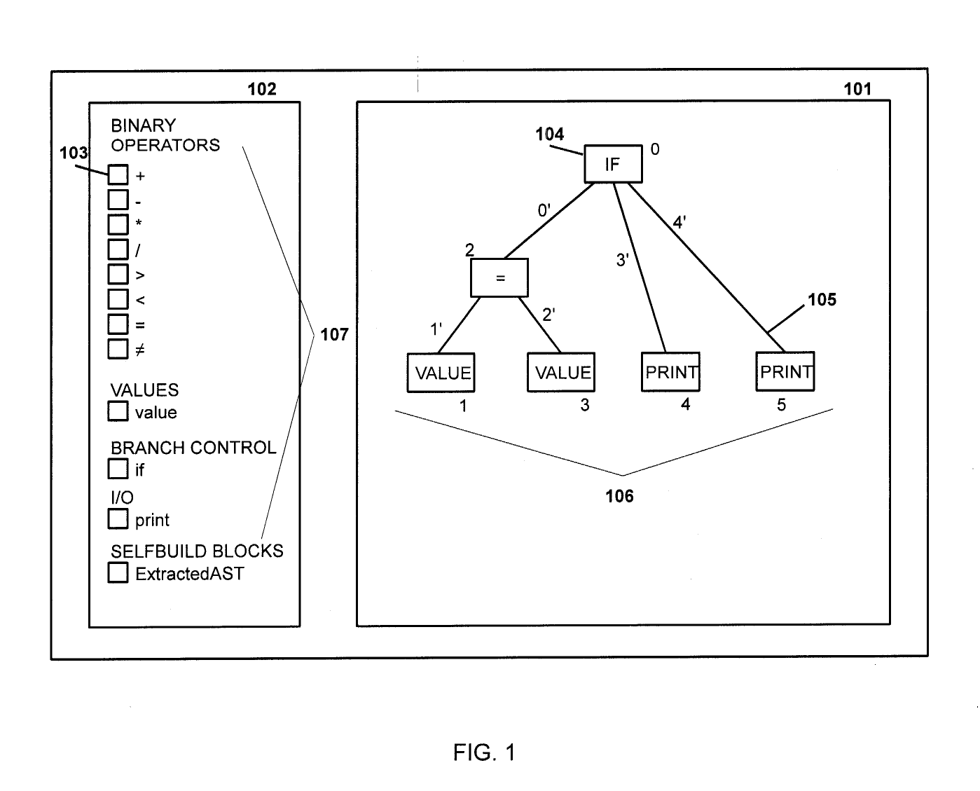

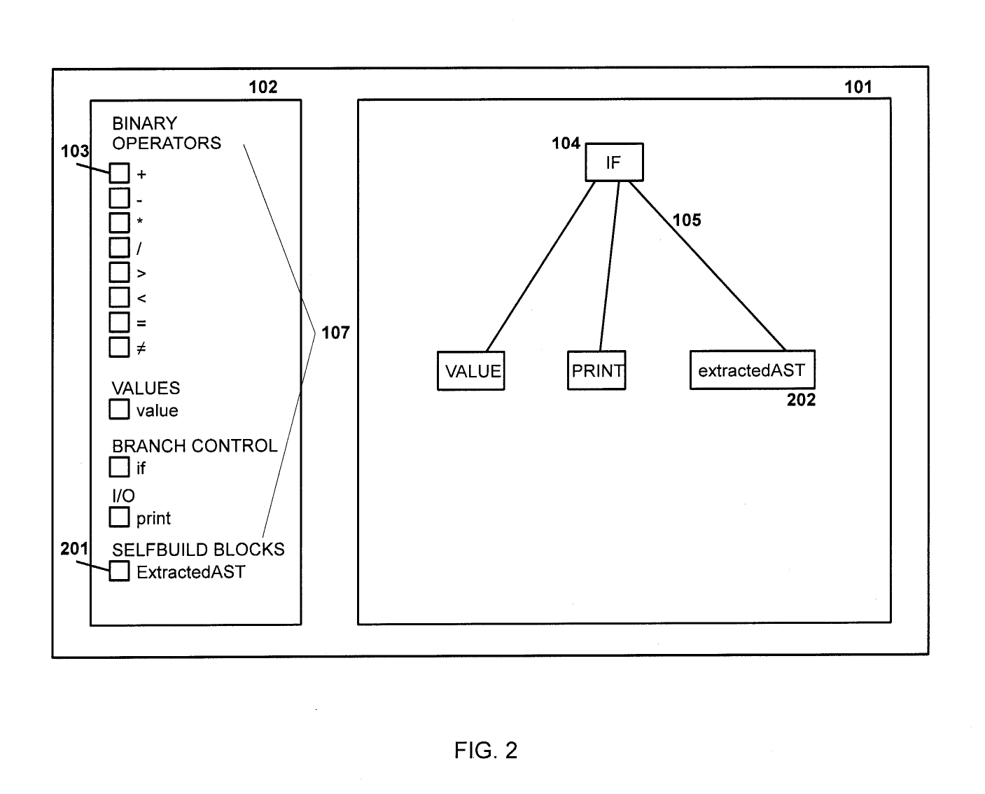

FIG. 1 and FIG. 2 illustrate a view of a user interface wherein a presentation pane 102 can be placed on the left of a canvas 101. A graphical representation of the abstract syntax tree is shown on the canvas 101. The canvas 101 can further display several nodes represented by identifiers 104. Lines 105, also known as edges, connect the identifiers 104 to represent the relationship between immediately related nodes. The overall structure of the identifiers 104 and line 105 represents the nodes and relationship data forming an abstract syntax tree. An abstract syntax tree is a data construct representing the abstract syntax of a computer program. Appropriate data constructs allow storage of data and the relationships between the data. Some examples may include objects, pointers, stacks, queues, arrays, trees, etc. A pool of elements 103 is displayed in the presentation pane 102 for user selection. The canvas 101 further displays several nodes represented by their identifiers 104 as a text label in a box. Lines 105 connect the nodes to represent the relationship between immediately related child and parent nodes. The user may click and drag the identifiers 104 to different positions on the canvas 101

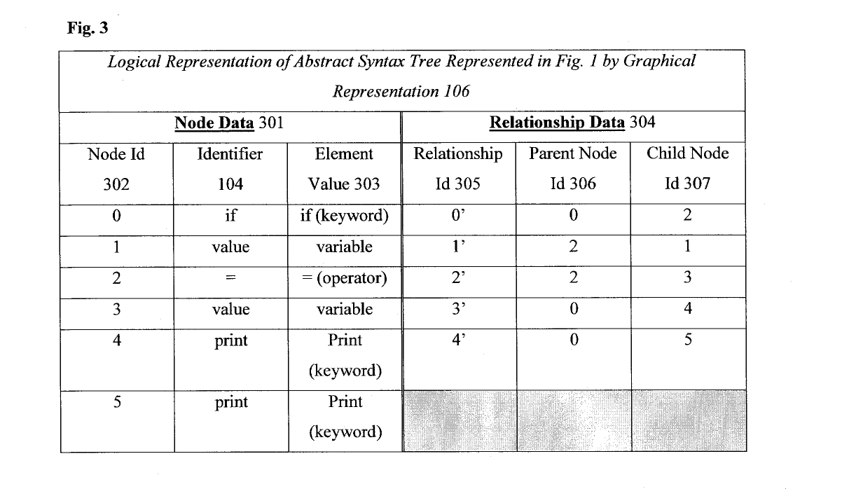

FIG. 3 illustrates a logical representation of the abstract syntax tree graphical representation 106. The abstract syntax tree may comprise node data 301 and relationship data 304. Nodes within the node data 301 may be denoted by node Id 302. The relationship data 304 may comprise parent-child relationships, denoted by Id 305, between nodes. A parent-child relationship, for example, may comprise storage of a parent node Id 306 and a child node Id 307, wherein the parent node Id 306 may match the node Id 302 of the parent node. Furthermore, the child node Id 307 may match the node Id 302 of the child node. A parent node may have multiple child nodes in relationship. This configuration may include multiple relationship Ids 305 between the parent node and multiple child nodes within the relationship data 304. Of course, each of these relationships in the relationship data 304 may contain the same parent node Id 306 and different child node Ids 307. These relationships may branch, and therefore a graphical representation 106 of the nodes 302 and relationships may resemble a tree diagram. Alternate embodiments include child nodes with multiple parent nodes.

A node may be a data construct in the abstract syntax tree. Nodes may comprise an identifier 104, and an element value 303. The element value 303 may comprise the property of the node 302 wherein the element of the node may be stored. The element may comprise an operator, value, variable, keyword, or the like. The identifier 104 may be a human recognizable representation of the element value 303 of the node such as a text, picture, icon, etc.

In one embodiment, each node comprises an identifier 104 that corresponds with the element value 303 in order to make the element value 303 of the node identifiable to an individual looking at the canvas 101. For example, a node with an element value 303 of the string, “hello world” may have the identifier 104 “hello world.” Alternatively, a node with an element value 303 of “=” (operator) may have the identifier 104 “=” (of type string). The node 302 may be represented graphically on a canvas 101 by the identifier 104. In some embodiments, the text of the identifier 104 may be encapsulated in a circle or a square.

A parent-child relationship may be represented graphically on the canvas 101 by a line 105 between identifiers 104 as depicted in FIGS. 1 and 2, wherein the higher positioned node 302 may be a parent node and the lower positioned node 302 may be a child node. An alternate embodiment depicts the relationship by connecting the line 105 at the bottom of the parent node identifier 104 and the top of the child node identifier 104.

A predefined set of elements 107 contains elements 103 that are useful in standard programming languages or in an abstract syntax tree. Each element 103 may contain one or more operators, keywords, variables, etc. Some examples include: if, then, for, while, do, break, continue, throw, catch, end, new, include, +, <, >, \, *, ̂, %, &, !, return, null, pointers, or, II, strings, variables, etc. The predefined set of elements 107 may be stored on a hard drive, memory, or other data storage device of a computer. Furthermore, the predefined set of elements 107 may be displayed in a pool. The pool may comprise an abstract data construct for storing a list of elements 103 or custom elements 201. The pool may be presented on screen within the presentation pane 102. The user can select one or more of the presented elements 103 from the pool. In one embodiment, the selection of one or more presented elements 103 is performed by a click and drag action or event from the presentation pane 102 on screen to a canvas 101 on screen. Other methods of selecting an element from the pool can include a dialog (not illustrated) wherein the predefined set of elements 103 is presented. Alternatively, click events on the elements 103 may be used. The computer may then create a node in the abstract syntax tree having an element value 303 matching the element 103 received from the user's selection and a human discernable identifier 104. The human discernable identifier 104 may be created by converting the element value 303 to a human readable string, such as the number 4 to a string “4.” The text representing a node may further be displayed on the canvas within a circle, square, or other shape and may be color coded for readability. Alternatively, certain elements may have preset icons or pictures that will be displayed as the identifier 104 of the node. The canvas 101 may then display an identifier 104 of the node as a text, an encircled text, an icon, a picture, etc., wherein the text communicates the node's element value to the user. Alternative embodiments may use pictures, icons, or any other method of communicating the element value 303 to the user. The process of adding nodes may be repeated until the abstract syntax tree contains sufficient nodes to represent a computer program designed by the user.

A node with an element value 303 equal to an element 103 from the predefined set of elements 107 may be further edited. For example, the element stored in the node may be assigned a type and/or value. This may be appropriate when the element of the node is a variable. In other embodiments, the element may be an operator or keyword. These nodes may be overloaded to redefine the operation of the element. The element value 303 may typically store changes to the element of the corresponding node, such as assigning a variable value or overloading an operator. Furthermore, the identifier 104 of the node may be edited by the user, for example, by replacing the identifier 104 of the node on the canvas 101 and in the stored node data 301 at the corresponding node id 302. A custom element 201 representing the edits to the node may be stored in the pool and presented in the presentation pane 102 with the predefined set of elements 107 for selection and reuse. Finally, nodes may be deleted (discussed in paragraph 0036) from the abstract syntax tree when the user deletes the identifier 104 from the canvas 101.

FIG. 2 illustrates a view of the interface of FIG. 1 wherein a compressed portion of an abstract syntax tree is represented by a custom identifier 202 on the canvas 101. In this embodiment, the compressed abstract syntax tree is presented to the user in the presentation pane 102 as a custom element 201 for selection and use on the canvas 101. Custom elements 201 may also include overloaded functions, variables with assigned type and/or value, may be stored in the pool and presented in the presentation pane 102 with the predefined set of elements 107. Furthermore, the portion of the abstract syntax tree may be stored as a custom element 201 in the pool and presented in the presentation pane 102 with the predefined set of elements 107. These custom elements 201 may include the nodes, relationships, and relative positioning of the nodes in the portion of the abstract syntax tree. In this manner, custom elements 201 may be quickly chosen to implement the high level programming equivalent of a user defined block or function. In some embodiments custom elements 201 may become large or complicated as they represent the functional equivalent of one or more user defined functions or blocks. Users often prefer to reuse libraries of user defined functions or blocks in conventional programming. Following this pattern, custom elements 201 may be presented to the user through the presentation pane 102, dialog (not illustrated), or other presentation device. The custom element 201 may then be selected for use on the canvas 101 and in the underlying syntax tree for use in the abstract syntax tree. In one embodiment, the entirety of the tree representing the nodes and relationships between the nodes may be displayed on the canvas 101. Other embodiments may display a partial tree, abbreviated tree, or a single node representing the tree of the custom element 201. Furthermore, the compressed abstract syntax tree may be expanded by user selection. Finally, some embodiments may allow the user to select the display style of the custom element 201 on the canvas 101.

Node positioning may be relevant in determining execution order of the abstract tree or machine executable code compiled from the abstract syntax tree. Lines 105 between the identifiers 104 may represent relationships between the nodes. As between immediately connected nodes, the nodes positioned higher on the canvas 101 may represent parent nodes. Furthermore, the immediately connected nodes positioned lower may be child nodes. In this manner, several generations of nodes may be connected creating a tree comprising branches. The expected order of traversing the branches may be from top to bottom and from left to right judged at the line 105 at the parent node identifier 104. In a left to right embodiment, execution would occur starting with the parent node. From the parent node, the child nodes may then be traversed from left to right following the branch to the bottom node. In this manner, the logic of a node tree may be read left to right. The example graphical representation 106 may be read according to this method of interpretation as: if value is equal to value then call a first print function else call a second print function.

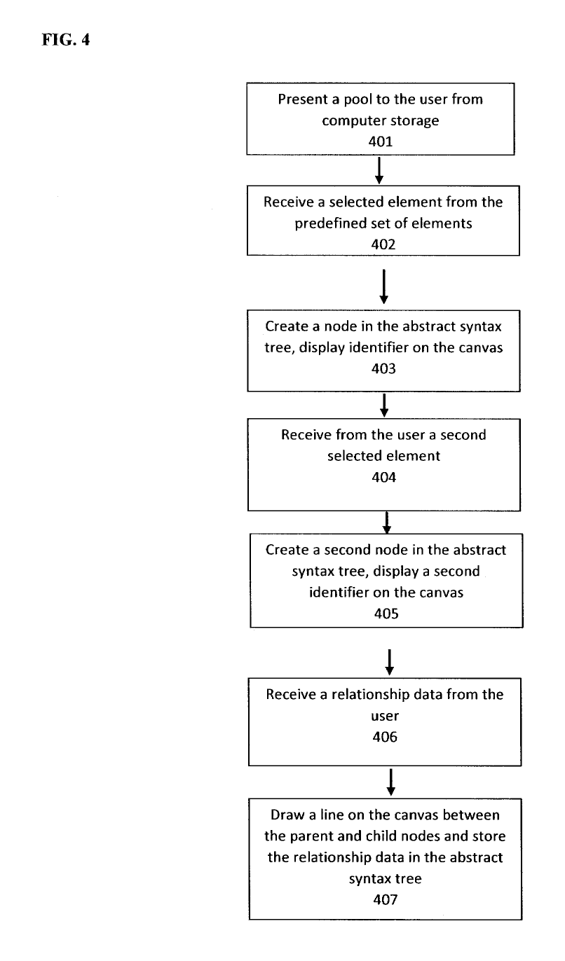

FIG. 4 illustrates a flow chart of an embodiment of the interface of FIGS. 1 and 2 wherein two elements and relationship data are received and an abstract syntax tree is built therefrom. In step 401 of FIG. 4, a pool is presented to the user from computer storage. The pool may comprise a set of predefined elements 107 and may further comprise one or more custom elements 201 defined by the user. The pool may be stored and retrieved from computer storage, such as a hard drive or memory. Step 402 may comprise receiving a selected element 103 or 201 from the predefined set of elements. This step may allow a user to select one or more of the presented elements in order to add one or more desired nodes to the abstract syntax tree.

The method of presentation and selection may occur through a dialog, a drag and drop, a signal, an interrupt, or other means of receiving a selection from a user. For example, a drag and drop may comprise selecting and dragging an element 103 from the presentation pane 102 and dragging and releasing the element 103 onto the canvas 101 via mouse and keyboard. Thereafter, the canvas 101 may display the identifier 104 that corresponds with the element 103. Additionally, drag and drop may occur via touchscreen wherein the user touches an area of the screen corresponding with selecting an element 103 from the presentation pane 102, sliding the element 103 to the canvas 101, and releasing the element 103. Furthermore, drag and drop may comprise interpreting motion via 3D camera on the input device wherein a movement may be interpreted as a click on the element 103 in the presentation pane 102, a second movement may drag the element 103 onto the canvas 101, and a third movement may drop the element 103 onto the canvas 101.

In step 403, a node may be created in the abstract syntax tree and the corresponding identifier 104 may be displayed on the canvas. Creating a node may comprise storing an element value 303, an identifier 104, and a relationship data 304 in the abstract syntax tree. The relationship data 304 may comprise a pointer to another node or a node Id 306 or 307 and a relationship status identifier, such as parent or child. Based on the element 103 selected, the element value 303 of the node may be set and the corresponding identifier 104 may be displayed on the canvas. In step 404, a second selected element may be received. In step 405, a second node can be created in the abstract syntax tree, and a relevant identifier may be displayed on the canvas 101. In step 406, a relationship data 304 may be received from the user. This relationship data may be stored in the abstract syntax tree and may identify a parent and a child node in the abstract syntax tree. In step 407, a line 105 may be displayed on the canvas between related nodes and the relationship data may be stored in the abstract syntax tree.

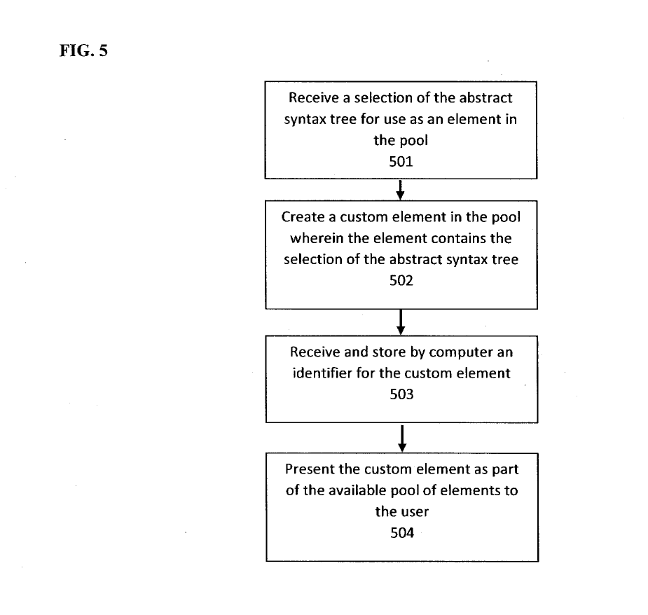

FIG. 5 illustrates a flow chart of an embodiment of the interface wherein a portion of an abstract syntax tree is stored as custom element 201. In step 501, the portion of the abstract syntax tree may be received by several methods. The portion of the abstract syntax tree may be uploaded by the user or the user may make a selection based on the elements displayed on the canvas 101. If the user makes a selection of identifiers via dialog, event, signal, interrupt, command, drag and drop, etc. marking multiple nodes for storage as a custom element 201, the node data 301 and relationship data 304 may be stored by computer. In step 502, the custom element 201 may be represented on the canvas 101 or in the pool as a single element. In embodiments wherein the custom element is presented in the pool, the custom element 201 is selectable in the same manner as the set of predetermined elements 107. Furthermore, the custom element 201 may be displayed on the canvas 101. Interactions, such as drag and drop for placement or for relationship editing, may occur in the same manner as between predetermined elements 107. In step 503, a custom identifier 202 may be received for the custom element 201. The custom identifier 202 may be created from one or more node identifiers represented by the custom element 201. Alternatively, the custom identifier 202 for the custom element 201 may be received from the user via input such as a keyboard or microphone. The custom identifier 202 may then be stored by computer. In step 504, the custom element 201 can be presented with the pool of elements 103 on the presentation pane 102. In turn, the user may select the custom element 201 for use on the canvas 101 in the same manner as the predefined elements 107.

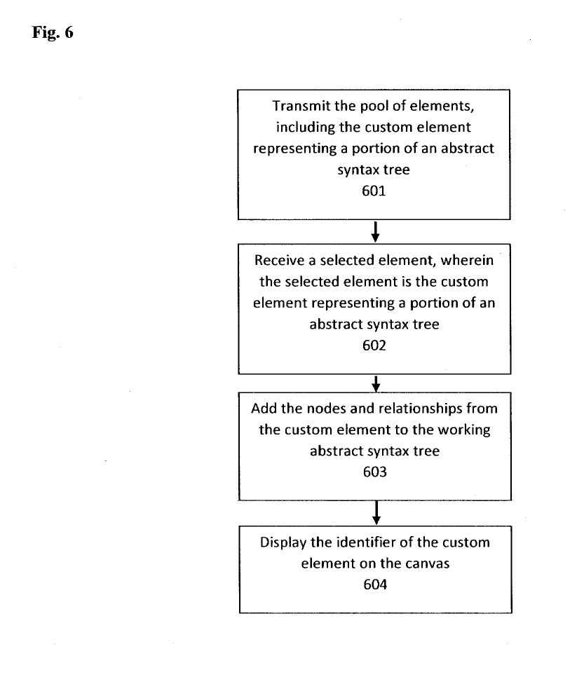

FIG. 6 illustrates a flow chart of an embodiment of the interface wherein a custom element 201 representing a portion of an abstract syntax tree is presented and used in abstract syntax tree. In step 601, the pool of elements 103 may be transmitted to the user through the presentation pane 102. This pool of elements 103 may include the set of predetermined elements 107 as well as user defined custom elements 201. In one embodiment, the custom element 201 represents a portion of an abstract syntax tree previously stored by the user. In step 602, the custom element may be received from the user as a selection. In one embodiment, the user may drag and drop the element 103 onto the canvas 101, displaying the custom element identifier 202. In step 603, the nodes and relationships represented by the identifier may be added to the abstract syntax tree. The user may create a line 105 between the custom element 201 identifier 202 on the canvas 101 and another identifier. The relationship between the root node of the portion of an abstract syntax tree and the other identifier may be stored. Alternatively, the relationship between the child node of the portion of an abstract syntax tree and the other identifier may be stored. In step 604, the custom identifier 202 and lines 105 may be displayed on the canvas 101 to correspond with the abstract syntax tree.

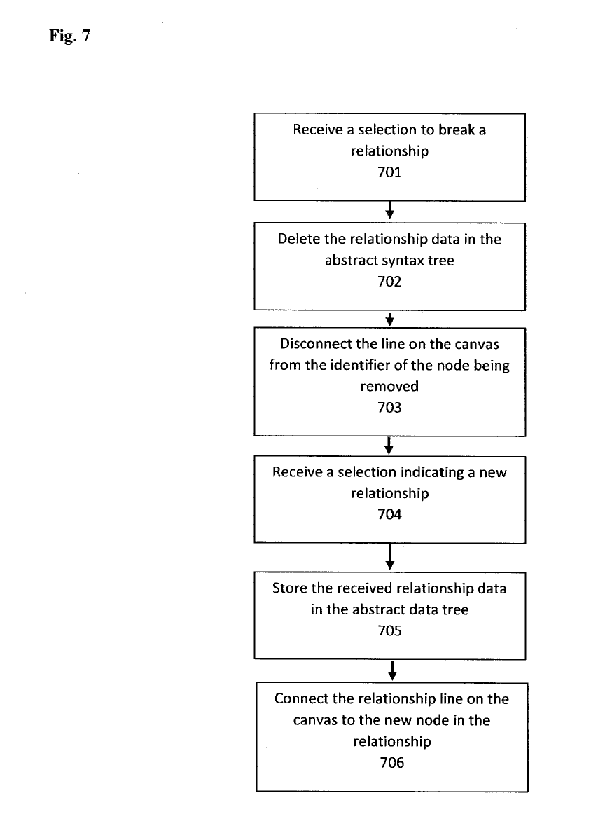

FIG. 7 illustrates a flow chart of an embodiment of the interface of FIG. 1 wherein a node is moved in the tree via the general user interface. In step 701, the user may select a node to move in the tree by selecting a line on the canvas representing the relationship to be changed on the canvas. If, for example, the parent is to be changed, the line at the parent identifier may be selected and placed on the new parent identifier. This causes the selection to break a relationship to be received. Within the abstract syntax tree, the relationship data storing the relationship between the previously related nodes, e.g. the nodes represented by previously connected identifiers, may be updated to include the new parent node, a pointer to the new parent node, or the address of the new parent node. In step 702, the updating process may comprise deleting the relationship data in the abstract syntax tree 702 and step 703 may comprise disconnecting the line 105 between previously related nodes. In step 704, a new relationship between nodes may be formed based on a selection that may be received indicating the new relationship. In step 705, creating a new relationship may comprise storing a new received relationship data in the abstract syntax tree. Step 706 may comprise connecting the newly related nodes with a line 105 on the canvas 101. A similar process may be followed for replacing a child node in the relationship. The user may select the line 105 at the child node, and place the line 105 on a new child node. The abstract syntax tree may be updated to reflect the changes in relationship data. Additionally, the user may drag and drop the identifier to a new location on the canvas for readability.

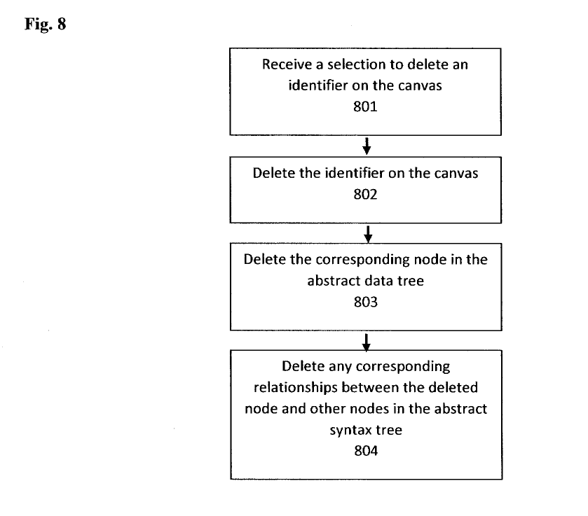

FIG. 8 illustrates a flow chart of an embodiment of the interface of FIG. 1 wherein a node is deleted via the general user interface. In step 801, a delete event may be triggered by the user selection, such as by right clicking the identifier of a node and selecting “delete.” In step 802, the identifier 104 may be removed from the canvas 101 as well as any lines 105 that connected to the node. In step 803, the node represented by the identifier 104 may also be deleted from the abstract syntax tree. In step 804, the relationship data representing relationships between the deleted node and other nodes in the abstract syntax tree may be deleted. Deletion may result in the removal of the node Id 302, identifier 104, and the element value 303 in the node data 301, as well as the relationship Id 305 and corresponding parent node Id 306, and child node Id 307 when the deleted node Id 302 is detected in the relationship data 304.

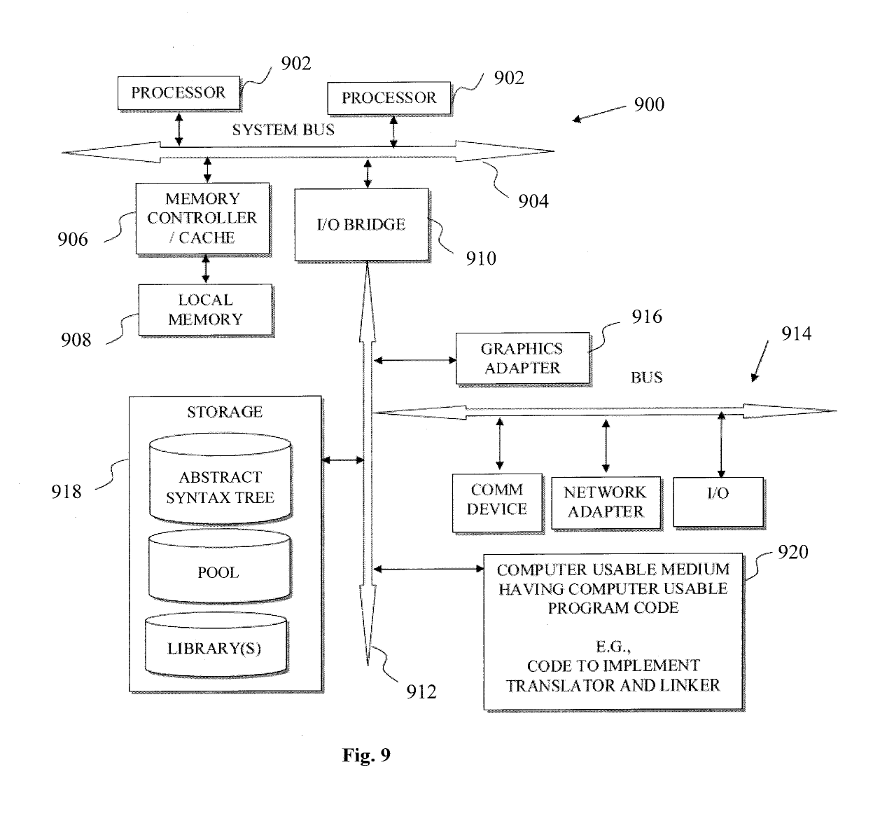

FIG. 9 is a block diagram of a computer system having a computer readable storage medium for implementing functions comprising aspects of the method detailed above. Data processing system 900 may comprise a symmetric multiprocessor (SMP) system or other configuration including a plurality of processors 902 connected to system bus 904. Alternatively, a single processor 902 may be employed. Also connected to system bus 904 is memory controller/cache 906, which provides an interface to local memory 908. An I/O bridge 910 is connected to the system bus 904 and provides an interface to an I/O bus 914. The I/O bus 912 may be utilized to support one or more buses and corresponding devices, such as bus bridges, input output devices (I/O devices), storage, network adapters, etc. Thus, a network adapter may be coupled to the system to enable the data processing system to become coupled to other data processing systems or remote printers or storage devices through intervening private or public networks.

Also connected to the I/O bus 912 may be devices such as a graphics adapter 916, storage 918 and a computer usable storage medium 920 having computer usable program code embodied thereon. The computer usable program code may be executed, e.g., by the processor(s) to implement any aspect of the present invention, for example, to implement any aspect of any of the methods, processes and/or system components illustrated in FIGS. 1-8. For instance, the computer usable program code can be utilized to implement a linker that implements any one or more of the methods of FIGS. 4-8. Moreover, the computer usable program code may be implemented in the local memory 908 or other suitable storage medium.

The storage 918 may store resources useful in implementing the features previously described. For instance, the storage 918 can store the computer instructions which, when executed, implement the interface of FIGS. 1 and 2, the abstract syntax tree, which may comprise the node data 301 and the relationship data 304, and the pool, which may comprise the predefined set of elements 107 and/or the custom elements 201, as well as any useful libraries for manipulating the storage of this data.

What is claimed is:

1. A method for graphically building an abstract syntax tree, comprising:
displaying, by the computer, a user interface comprising a canvas and a presentation pane;
displaying, by the computer, on the canvas a depiction of the abstract syntax tree;
displaying, by the computer, within the presentation pane a plurality of elements, wherein each of the plurality of elements is selectable as a visual node to add to the depiction of the abstract syntax tree;
receiving, by the computer, first input indicating selection of one of the plurality of elements; and
adding, by the computer, to the canvas a first node in the depiction of the abstract syntax tree with a first visual label related to the one of the plurality of elements.

2. The method of claim 1, comprising:
receiving, by the computer, second input indicating selection of a second one of the plurality of elements;
adding, by the computer, to the canvas a second node in the depiction of the abstract syntax tree with a second visual label related to the second one of the plurality of elements;
receiving, by the computer, third input indicating a relationship between the first one and the second one of the plurality of elements; and
displaying, by the computer, on the canvas a connector in the depiction of the abstract syntax tree which visually links the first node and the second node.

3. The method of claim 1, wherein the plurality of elements comprises: binary operators, values, and branch control statements.

4. The method of claim 1, comprising:
receiving, by the computer, second input indicating a selection of a subset of nodes and edges displayed in the depiction of the abstract syntax tree on the canvas;
compressing, by the computer, the subset of nodes and edges to a single element block; and
displaying, by the computer, in the presentation pane a corresponding identifier for the single element block.

5. The method of claim 1, wherein the plurality of elements comprises a predefined element wherein the predefined element comprises at least a portion of a compressed abstract syntax tree having a plurality of nodes.

6. The method of claim 5, wherein the at least a portion of the compressed abstract syntax tree is displayed as a single element within the presentation pane.

7. The method of claim 6, comprising:
receiving, by the computer, second input indicating selection of the predefined element; and
adding, by the computer, to the canvas a second node in the depiction of the abstract syntax tree with a second visual label related to the at least a portion of the compressed abstract syntax tree.

8. The method of claim 7, comprising:
expanding, by the computer, the at least a portion of the compressed abstract syntax tree to display on the canvas all of the plurality of nodes of the at least a portion of the compressed abstract syntax tree.

9. The method of claim 1, wherein the first input comprises a drag-and-drop operation from a touch screen that results in dragging a copy of the one of the plurality of elements from the presentation pane to the canvas.

10. The method of claim 1, wherein the first input comprises a drag-and-drop operation from a 3D camera that results in dragging a copy of the one of the plurality of elements from the presentation pane to the canvas.

11. A system for graphically building an abstract syntax tree, comprising:
a memory storing executable instructions;
a computer configured to execute the executable instructions stored in the accessible memory;
the computer when executing the executable instructions stored in the accessible memory:
displays a user interface comprising a canvas and a presentation pane;
displays on the canvas a depiction of the abstract syntax tree;
displays within the presentation pane a plurality of elements, wherein each of the plurality of elements is selectable as a visual node to add to the depiction of the abstract syntax tree;
receives first input indicating selection of one of the plurality of elements; and
adds to the canvas a first node in the depiction of the abstract syntax tree with a first visual label related to the one of the plurality of elements.

12. The system of claim 11, wherein, when executing the executable instructions stored in the accessible memory, the computer:
receives second input indicating selection of a second one of the plurality of elements;
adds to the canvas a second node in the depiction of the abstract syntax tree with a second visual label related to the second one of the plurality of elements;
receives third input indicating a relationship between the first one and the second one of the plurality of elements; and
displays on the canvas a connector in the depiction of the abstract syntax tree which visually links the first node and the second node.

13. The system of claim 11, wherein the plurality of elements comprises: binary operators, values, and branch control statements.

14. The system of claim 11, wherein, when executing the executable instructions stored in the accessible memory, the computer:
receives second input indicating a selection of a subset of nodes and edges displayed in the depiction of the abstract syntax tree on the canvas;
compresses the subset of nodes and edges to a single element block; and
displays in the presentation pane a corresponding identifier for the single element block.

15. The system of claim 11, wherein the plurality of elements comprises a predefined element wherein the predefined element comprises at least a portion of a compressed abstract syntax tree having a plurality of nodes.

16. The system of claim 15, wherein the at least a portion of the compressed abstract syntax tree is displayed as a single element within the presentation pane.

17. The system of claim 16, wherein, when executing the executable instructions stored in the accessible memory, the computer:
receives second input indicating selection of the predefined element; and
adds to the canvas a second node in the depiction of the abstract syntax tree with a second visual label related to the at least a portion of the compressed abstract syntax tree.

18. The system of claim 17, wherein, when executing the executable instructions stored in the accessible memory, the computer:
expands the at least a portion of the compressed abstract syntax tree to display on the canvas all of the plurality of nodes of the at least a portion of the compressed abstract syntax tree.

19. The system of claim 11, comprising:
a touch screen and wherein the first input comprises a drag-and-drop operation from the touch screen that, when executed, results in dragging a copy of the one of the plurality of elements from the presentation pane to the canvas.

20. The system of claim 11, comprising:
a 3D camera and wherein the first input comprises a drag-and-drop operation from the 3D camera that, when executed, results in dragging a copy of the one of the plurality of elements from the presentation pane to the canvas.

21. A computer program product for graphically building an abstract syntax tree, comprising:
a non-transitory computer readable storage medium having computer readable program code embodied therewith, the computer readable program code comprising:
computer readable program code configured to display a user interface comprising a canvas and a presentation pane;
computer readable program code configured to display on the canvas a depiction of the abstract syntax tree;
computer readable program code configured to display within the presentation pane a plurality of elements, wherein each of the plurality of elements is selectable as a visual node to add to a depiction of the abstract syntax tree;
computer readable program code configured to receive first input indicating selection of one of the plurality of elements; and
computer readable program code configured to add to the canvas a first node in the depiction of the abstract syntax tree with a first visual label related to the one of the plurality of elements.
